(19) United States
(12) Patent Application Publication
(10) Pub. No.: US 2021/0197838 A1
(43) Pub. Date: Jul. 1, 2021

(54) METHOD FOR ADAPTING THE COMFORT OF A VEHICLE, REGULATING DEVICE AND VEHICLE

(71) Applicant: ZF Friedrichshafen AG, Friedrichshafen (DE)

(72) Inventors: Florian DAUTH, Kressbronn (DE); Volker WAGNER, Ravensburg (DE)

(21) Appl. No.: 16/757,588

(22) PCT Filed: Sep. 5, 2018
(86) PCT No.: PCT/EP2018/073839

§ 371 Date: Apr. 20, 2020

(30) Foreign Application Priority Data
Nov. 3, 2017 (DE) 10 2017 219 585.1

(51) Int. Cl. B60W 50/00; B60G 17/016; B60W 50/16

(52) U.S. Cl. CPC B60W 50/0098; B60W 2050/146; B60W 50/16; B60G 17/016

(57) ABSTRACT

A method for adapting the comfort of a vehicle for a vehicle user. The vehicle has an HMI system with which the user and vehicle interact. A suspension system adapts a position of the user to a roadway. A position planning device plans and regulates movement of the vehicle. A regulating device, which has a memory, is connected to the HMI and a suspension system and the position planning device. According to the method, a target comfort zone for the user is stored in the regulating device memory. A current comfort zone of the user is continuously determined, via the HMI system, and continuously compared with the target comfort zone. Based on comparison results, the regulating device controls the suspension system, the position of the user being adapted to the roadway such that the current comfort zone continues approaching the target comfort zone until the target comfort zone is reached.

This application is a National Stage completion of PCT/EP2018/073839 filed Sep. 5, 2018, which claims priority from German patent application serial no. 10 2017 219 585.1 filed Nov. 3, 2017.

### FIELD OF THE INVENTION

The present invention relates to a method for adapting the comfort of a vehicle as well as to a regulating device for a vehicle and to a vehicle.

### BACKGROUND OF THE INVENTION

With increasing automation of the task of driving in road traffic, the driver has less and less control over the vehicle and is becoming a passenger. This enables him to carry out sideline activities in the vehicle, such as reading, working or even sleeping. If the vestibular senses of people do not match what they see, this can result in discomfort and particularly also in motion sickness (travel sickness, kinetosis). The sideline activities of a vehicle user in the vehicle have the result that the user cannot be fully aware of the surroundings and consequently cannot assess the current movement of the vehicle, nor anticipate future movements of the vehicle.

From DE 20116469 U1 a system for suppressing motion sickness in vehicles is known. The system comprises at least one sensor for detecting the acceleration of the vehicle and/or the speed of the vehicle and/or a vehicle distance. In addition the system comprises at least one control device and at least one display device present in the vehicle. With the information from the sensor or sensors the control device assesses the driving situation and displays it by way of the display device.

From DE 10 2014 210 170 A1 a method for suppressing motion sickness in a motor vehicle is known. To a passenger in the vehicle, acoustic, visual and/or haptic signals are sent as a function of a detected or predictable driving situation. The haptic signals are in the form of airflows.

From DE 10156219 C1 a method and a device for reducing the kinetosis effect in passengers of traffic and transport means is known. By means of optical reproduction devices, the passengers are supplied with image signals which, as a function of travel-specific movement data, are modified in such manner that for the passenger the visual impression of the images considered matches the current subjectively perceived position and movement values.

From DE 102014013585 A1 a method is known for controlling a behavior of a vehicle while it is traveling along a route. For realizing a tilting technology for the vehicle, at least one tilting angle about a body axis of the vehicle is influenced.

### SUMMARY OF THE INVENTION

Starting from the prior art, the purpose of the present invention is to propose an improved method for increasing the comfort of a vehicle user.

Starting from the above-mentioned objective, the present invention proposes a method for adapting the comfort of a vehicle, a regulating device for a vehicle and a vehicle according to the independent claim(s). Further advantageous design features and further developments emerge from the subordinate claims.

To carry out a method for adapting the comfort of a vehicle for at least one user of the vehicle, the vehicle comprises a human-machine-interface (HMI) system for interaction between the at least one vehicle user and the vehicle. Moreover, the vehicle has a chassis system for adapting a position of the at least one vehicle user relative to a roadway. Furthermore, the vehicle comprises a position planning device for planning and regulating a movement of the vehicle. In addition the vehicle has a regulating device which is connected to the HMI system, the position planning device and the chassis system, wherein the regulating device comprises a memory.

In accordance with the method, a target comfort level for the at least one vehicle user is stored in the memory of the regulating device. By means of the HMI system a current comfort level of the at least one vehicle user is continuously determined. The current comfort level is continuously compared with the target comfort level. On the basis of the result of the comparison, the regulating device controls the chassis system whereby the position of the at least one vehicle user relative to the roadway is adapted in such manner that the current comfort level approaches the target comfort level until the target comfort level has been reached.

Here, the vehicle is a passenger car, a utility vehicle or a similar vehicle. The vehicle is capable of driving autonomously or automatically. In other words, in certain situations or indeed always, the vehicle no longer needs a driver. The vehicle can autonomously detect, assess and react appropriately to traffic situations. Put differently, it controls itself. The driver becomes a vehicle user who does not have to concentrate on the road traffic during a journey, but can direct his attention away from the roadway and onto other activities. Moreover, he can take his hands off the steering wheel or suchlike. Thus the vehicle is capable, for example, of displaying a level-3, level-4 or level-5 degree of automation.

The method is applied for at least one vehicle user. Obviously, the vehicle can be used by more than one user. In that case the method is applied for each of the vehicle users. For example, when there are several users of the vehicle, an average comfort level of all the vehicle users can be chosen as the target comfort level. Alternatively, the target comfort level for a particular vehicle user can be adopted as the target comfort level for all the vehicle users, for example the vehicle user with the least demanding current comfort level.

The HMI system is designed for interaction between the at least one vehicle user and the vehicle itself. In other words, by means of the HMI system the vehicle user can pass on data and information to the vehicle or, more precisely, to a sub-system of the vehicle. Likewise, by way of the HMI system the vehicle user can receive data and information from the vehicle or, more precisely, from a sub-system of the vehicle. Thus, the HMI system serves to enable communication between the vehicle user and the vehicle. In this context a sub-system is an individual vehicle system which carries out functions in the vehicle, such as an air-conditioning unit, an entertainment system, a chassis system or the like.

The HMI system has at least one output device and at least one input device. The input device serves to pick up data and information from the vehicle user. The output device serves to convey data and information to the vehicle user. The input device can for example be designed as an optical sensor such as an inside-space camera which monitors the vehicle user. Alternatively or in addition, the input device can be in the form of a touch-screen, so that the vehicle user can enter data via the touch-screen. Alternatively or in addition, the input device can be in the form of an acoustic sensor so that the vehicle user can input data verbally, or sounds can be detected. Alternatively or in addition, the input device can be a vitality sensor system such that one or more vital parameters of the vehicle user is/are monitored. The HMI system can either itself evaluate the data determined or received, or pass them on to the regulating device which then carries out the evaluation.

The chassis system serves to adapt the position of the at least one vehicle user relative to the roadway. During this the vehicle is moving along the roadway. The chassis system makes it possible to regulate the tilt, the tilting speed and the tilting acceleration of the vehicle user about a longitudinal axis, a transverse axis and a vertical axis of the vehicle. The longitudinal axis is defined by the longitudinal direction of the vehicle, the transverse axis by the transverse direction of the vehicle and the vertical axis by the vertical direction of the vehicle. For this purpose the chassis system can comprise an adaptive chassis or an adaptive cabin mounting or a combination of the two. Furthermore, in addition or alternatively the chassis system can comprise a rear-axle steering system. Adaptive should be understood in the sense of being adaptable. In other words, the chassis system comprises for example a tilting mechanism. In addition the chassis system can enable regulation of a vehicle chassis and vehicle damping system. For that purpose the chassis system can have adaptive chassis and damping means. The chassis system can be equipped with sensors which determine the current tilt and the current damping. These tilt and damping data can be evaluated either by the sensor itself or passed on to the regulating device which evaluates the tilt and damping data.

The position planning device is designed to plan and regulate the movement of the vehicle. This planning is based on efficiency, safety and comfort parameters. The planning is carried out by means of algorithms. The position planning device plans the movement of the vehicle in relation to the driving maneuvers that have to be carried out when starting off on an overall route. For example, the planning of the driving maneuvers includes the planning of vehicle speeds, curve radii, vehicle accelerations, and thus trajectories. In this context a trajectory is a bend in the road around which the vehicle moves with a particular speed profile. In addition the position planning device can plan the movement of the vehicle in relation to the route as a whole, i.e. it can establish the route to be covered. For this the position planning device comprises a position determining system such as a GPS system, a C2X system or some similar system. The position planning device passes data relating to the movement of the vehicle on to the regulating device.

The vehicle comprises a regulating device connected to the HMI system, the position planning device and the chassis system, such that the regulating device comprises a memory. Obviously, the regulating device can be connected to other vehicle systems or subsystems. The memory is a data memory. The regulating device is for example in the form of an ECU (engine control unit) or ECU domain. Data can be exchanged between the regulating device, the HMI system, the chassis system and the position planning device. In other words the regulating device can receive data from the HMI system, from the chassis system and from the position planning device. Furthermore, the regulating device can control the HMI system, the chassis system and the position planning device. The regulating device can actuate the chassis system in such manner that it adapts the position of the at least one vehicle user relative to the road. The regulating device can control the HMI system in such manner that it communicates information to the at least one vehicle user, for example regarding the trajectories of the vehicle, and monitors the at least one vehicle user. The regulating device can control the position planning system in such manner that it plans the movement of the vehicle in a predefined way, for example to carry out agile driving maneuvers with tight curve radii and at a higher speed. The parameters of the predetermined driving maneuvers are stored in the memory of the regulating device. For example, these parameters can be the vehicle's speed, the vehicle's acceleration, the steering angle, the tilt of the vehicle, or suchlike.

In the memory of the regulating device a target comfort level for the at least one vehicle user is stored. This target comfort level is the comfort level in which the visual impressions of the at least one vehicle user match the perceptible drive dynamics of the vehicle. Moreover, in this target comfort level the at least one vehicle user has a sufficiently large anticipation capacity for drive dynamics that are likely to occur. A further property of the target comfort level is a sufficiently high feeling of safety of the at least one vehicle user in the vehicle. The driving style of the vehicle does not give rise to any unpleasant emotions or anxiety conditions in the at least one vehicle user. At this target comfort level the vehicle user, for example, feels well and shows no signs of discomfort. For example, at the target comfort level the vehicle user shows no signs of motion sickness, he is not stressed, and his vital parameters are in a range that corresponds to a stress-free condition.

For example the at least one vehicle user can himself specify his preferred target comfort level and store it in the memory. Alternatively, the target comfort level can be stored in the memory as a general target comfort level established for example by statistical evaluations of a sufficiently large test group. As a further alternative, the target comfort level can be determined in a calibration phase by means of the HMI system. In that case the target comfort level is not changed as a function of the driving situation or of the sideline activities pursued. In other words the target comfort level always remains the same.

While the method for adapting the comfort of the at least one vehicle user is in progress, by means of the HMI system a current comfort level of the at least one vehicle user is continuously determined. In other words the determination of the current comfort level takes place without interruption, i.e. during the entire journey of the vehicle for as long as the at least one vehicle user is in the vehicle. The HMI system determines the current comfort level by means of its input device. For example, the at least one vehicle user is monitored by optical, acoustic and/or vitality sensors. Alternatively or in addition the at least one vehicle user can input his current comfort level manually. Thus, the condition of the vehicle user is monitored.

The current comfort level is then compared continuously with the target comfort level. This continuous comparison means that a control cycle takes place. The current comfort level is continuously determined and if this is different from the target comfort level a regulation measure is carried out by the regulating device. The regulating device then actuates the chassis system in order to modify the position of the at least one vehicle user relative to the road, so that the current comfort level approaches the target comfort level until the target comfort level has been reached. The position of the at least one vehicle user relative to the road is changed until his current comfort level is the same as the target comfort level. When that is the case, the current comfort level of the at least one vehicle user continues to be determined by the HMI system.

For example, the position of the at least one vehicle user relative to the road is modified in such manner that no, or only small centrifugal forces act upon the at least one vehicle user. Alternatively or in addition the position of the at least one vehicle user relative to the road can be modified in such manner that uneven roadway features such as bumps or potholes are not noticed, or only slightly so. Alternatively or in addition, pitching movements of the vehicle while accelerating or braking can be compensated, so that no, or only slight longitudinal accelerations act upon the at least one vehicle user.

An advantageous feature of this method is that the chassis system is only controlled and regulated as a function of the current comfort level of the at least one vehicle user. Thus, the position of each vehicle user can be adapted individually to suit the way he feels. This is advantageous because different vehicle users at different times will have different perceptions of comfort. For example, a position relative to the road of a vehicle user whose current comfort level is close to the target comfort level will have to be adapted less than that of a vehicle user whose current comfort level is very different from the target comfort level. Again for example, a position relative to the road of a vehicle user who is attentively observing what is happening during the journey will have to be adapted less than that of a vehicle user who is pursuing some sideline activity.

According to an embodiment, on the basis of the comparison result the regulating device controls the HMI system as well as controlling the chassis system. The current movement data of the position planning device of the vehicle are communicated to the at least one vehicle user by way of the HMI system, whereby the current comfort level approaches the target comfort level until the target comfort level is reached. Thus for example, the speed, the acceleration, the gradient angle, the tilt angle, the curve radius and/or the driving direction are communicated to the at least one vehicle user. This contributes toward increasing the comfort of the vehicle user, since without having to follow the driving situation he can know how the vehicle is moving. In that way the at least one vehicle user can anticipate the drive dynamics of the vehicle.

Communication takes place by way of the output device of the HMI system. For example, an acoustic, haptic and/or visual output, or a combination of them, can take place.

In a further embodiment the future movement data of the position planning device of the vehicle are communicated to the at least one vehicle user by the HMI system. Thus, the at least one vehicle user is made aware of the movement data that will apply at some future time. For example, with reference to a route being covered the at least one vehicle driver can be made aware of the speed, acceleration, gradient angle, tilt angle, curve radius and/or driving direction that will exist at some future time. These future movement data are produced with reference to the planning by the position planning device.

During this the time horizon up to which the future movement data should be communicated can be set, for example by the at least one user of the vehicle. For example the user can specify that he only gets the movement data that will become current for example in at most 5 min or 10 min, or for example data that will become current in at most 0.5 km, 1.0 km or 1.5 km. The numbers given here are chosen purely as examples.

According to a further embodiment the regulating device additionally controls an interior system of the vehicle. The interior system is adapted in such manner that the current comfort level approaches the target comfort level until the target comfort level has been reached, so the vehicle comprises an interior system which is connected to the regulating device. The interior system comprises, for example, adjustable vehicle seats, air-conditioning and ventilation of the vehicle, inside-space lighting, an entertainment system, or further systems arranged inside the vehicle. Thus, interior system is a general term for all the systems within the inside space of the vehicle. The interior system is connected to the regulating device so that data exchange can take place between the regulating device and the interior system.

The regulating device controls the interior system on the basis of the comparison result between the target comfort level and the current comfort level of the at least one vehicle user, and carries out adaptations of the interior system. These adaptations are carried out until the current comfort level of the at least one vehicle user matches the target comfort level. These adaptations take place in addition to the change of the position of the vehicle user relative to the road.

For example, the air-conditioning and ventilation of the inside space of the vehicle are adapted so that fresh air intake is increased and/or the temperature of the inside space is brought to a desired value, for example to around 21° C. In addition or alternatively, for example the vehicle seats are adjusted so that the at least one vehicle user adopts a different sitting position such as an upright sitting position or a lying position. In addition or alternatively, the lighting of the inside space of the vehicle is adapted, for example dimmed or colored. In addition or alternatively, for example the entertainment system is switched on, switched off, or tuned to a predetermined medium (music, video, images, audio book, etc.).

In a further embodiment the HMI system determines an attentiveness level of the at least one vehicle user. The determination of the attentiveness level is part of the monitoring of the driver's condition and thus part of the determination of the current comfort level. The attentiveness level can for example be determined in a conventional manner, for example on the basis of eye movements or head movements of the at least one vehicle user. In that way it is determined whether the at least one vehicle user is distracted, because for example he is pursuing a sideline activity, or whether he is following the driving situation attentively because his eyes are directed attentively on the roadway. The attentiveness level can also be influenced by an anticipation capability of the at least one vehicle user and by his sense of security.

In the case of an inattentive vehicle user, his perception of the driving situation is very different from the actual driving situation. This can induce motion sickness. The current comfort level of an inattentive vehicle user is therefore different from the current comfort level of an attentive vehicle user. Accordingly, in the case of an inattentive vehicle user greater adaptations of the chassis system must therefore be carried out than for attentive vehicle users. For example, with an inattentive vehicle user both his position relative to the roadway can be adapted by means of the chassis system and also the current and future movement data can be communicated. In contrast, with an attentive vehicle user it is acceptable to adapt only his position relative to the roadway by means of the chassis system, whereas the communication of movement data can be omitted since the attentive vehicle user is observing the driving situation.

According to a further embodiment, the position planning device plans trajectories of the vehicle as part of the movement data, and these trajectories are communicated to the at least one vehicle user by means of the HMI system. For example the trajectories are communicated to the at least one vehicle user by visual, acoustic or haptic means. For example it can be displayed to the at least one vehicle user what curve radius a curve in the roadway is being driven through, and at what speed. Thus, the user can adjust to the driving movement without observing the driving situation.

In a further embodiment the regulating device also controls the position planning device, so that planned vehicle movement is adapted in such manner that the current comfort level approaches the target comfort level until the target comfort level is reached. In this case the regulating device has a direct influence on the planning of the movement of the vehicle. For example, if the current comfort level of the at least one vehicle user is found to be very different from the target comfort level, a smoother movement is planned, i.e. fewer tight curve radii and lower speeds than with a vehicle user whose current comfort level is close to the target comfort level.

Furthermore, from the beginning of the journey a route can be selected which matches a current comfort level. For example, if there is a large difference between the target comfort level and the current comfort level, a less demanding route can be chosen which, for example, demands lower speeds, smaller accelerations or fewer bends.

In a further embodiment, starting from vital parameters a current comfort level of the at least one vehicle user is determined. These vital parameters provide information about the current state of health of the at least one vehicle user. From them, a current comfort level is deduced by means of algorithms.

According to a further embodiment, the HMI system communicates visually and/or acoustically and/or haptically with the at least one vehicle user. Obviously, a combination of two or all three communication options is possible.

A regulating device for a vehicle can be connected to an HMI system, a chassis system and a position planning device of the vehicle. Furthermore, the regulating device can be connected to an interior system. In this context ‘can be connected’ means that a connection can be made. The connection is such that data exchange can take place. The regulating device has already been described in the above description. The HMI system, the chassis system, the position planning device and the interior system have already been described in the above description. The regulating device carries out the method for adapting the comfort of the vehicle for at least one vehicle user, as already described in the above description. The regulating device also comprises a memory. The memory is a data memory. Obviously, the regulating device can be connected to further vehicle systems or subsystems. The regulating device is for example in the form of an electronic control unit (ECU) or an ECU domain.

A vehicle for at least one vehicle user comprises an HMI system, a chassis system and a position planning device. In addition the vehicle can comprise an interior system. The vehicle has a regulating device. The HMI system, the chassis system, the position planning device, the interior system and the regulating device have already been described in the above description. The vehicle implements the method for adapting the comfort of the vehicle for at least one vehicle user, as has already been described in the above description.

### BRIEF DESCRIPTION OF THE DRAWINGS

Various example embodiments and details of the invention are described in greater detail with reference to the figures explained below, which show:

FIG. 1: A schematic representation of a regulating device according to an example embodiment, which device can carry out the method for adapting comfort,

FIG. 2: A schematic representation of a vehicle according to a further example embodiment, with the regulating device from FIG. 1,

FIG. 3: A schematic representation of a control cycle according to an example embodiment, which is implemented by the regulating device from FIG. 1 when carrying out the method.

### DETAILED DESCRIPTION OF THE PREFERRED EMBODIMENTS

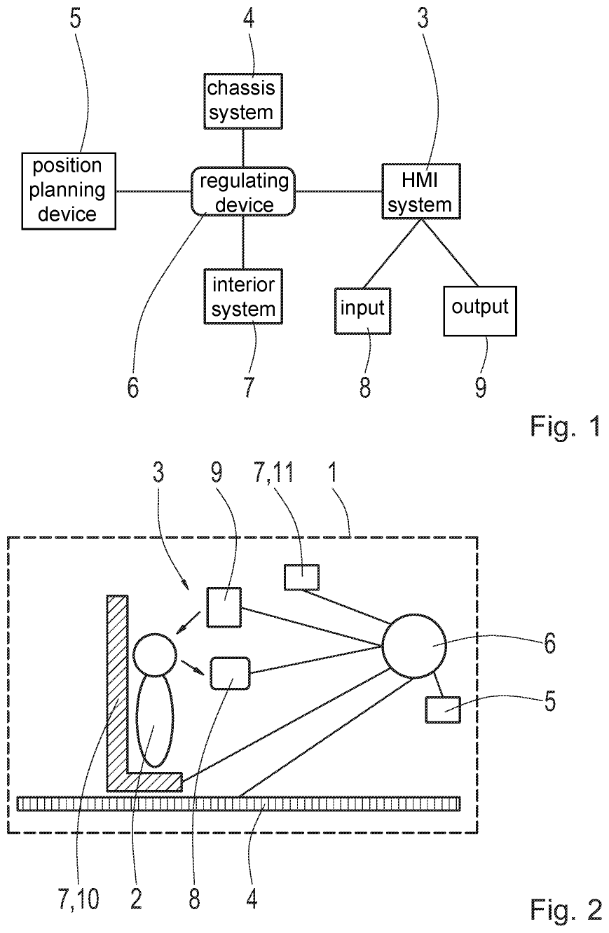

FIG. 1 shows a schematic representation of a regulating device 6 according to an example embodiment, which can carry out the method V for adapting comfort. The figure shows the regulating device 6, which is connected to various systems of the vehicle 1. The regulating device 6 is connected to the chassis system 4, the position planning device 5, the interior system 7 and the HMI system 3. In this case the HMI system 3 has an input device 8 and an output device 9.

The regulating device 6 is connected to the other systems in such manner that data exchange can take place. Thus, the regulating device 6 can receive data from the individual systems or send data to those systems. In addition the regulating device 6 can control the chassis system 4, the interior system 7, the position planning device 5 and the HMI system 3. The regulating device 6 can control the input device 8 and the output device 9 of the HMI system independently of one another. The regulating device 6 is for example in the form of an ECU or an ECU domain.

The input device 8 of the HMI system 3 serves to receive information and data from a vehicle user 2. The output device 9 of the HMI system 3 serves to output data and information to the vehicle user 2. The data which the input device 8 of the HMI system 3 has received from the vehicle user 2 can either be evaluated by the HMI system 3 itself, or passed on to the regulating device 6 which then takes over the evaluation. The data reception can take place via acoustic, visual or haptic means, or a combination of them. The regulating device 6 can control the output device 9 of the HMI system 3 in such manner that particular information or data are displayed or output to the vehicle user 2 at particular times. This can take place by acoustic, visual or haptic means, or a combination of them.

The regulating device 6 can control the chassis system 4 in such manner that a position of the vehicle user 2 relative to the roadway is changed. This takes place in order to influence a current comfort level of the vehicle user 2 in a positive manner.

From the position planning device 5, the regulating device 6 receives data about a plan for the movement of the vehicle 1. These data can be output to the vehicle user 2 by means of the HMI system 3, or more precisely by means of the output device 9. The regulating device 6 can also control the position planning device 5 in such manner that it plans the movement of the vehicle 1 so as to have a positive effect on a current comfort level of the vehicle user 2.

The regulating device 6 can control the interior system 7 in such manner as to adapt it so as to change a current comfort level of the vehicle user 2 in a positive way. For example, the interior system 7 comprises an air-conditioning unit 11 or an adjustable vehicle seat 10. The regulating device 6 can control each individual system of the interior system 7 and adjust it so as to change a current comfort level of the vehicle user 2 to positive effect. For example, by means of the air-conditioning unit a vehicle temperature can be varied.

FIG. 2 shows a schematic representation of a vehicle 1 according to a further example embodiment, which comprises the regulating device 6 of FIG. 1. The figure shows the vehicle 1 with the vehicle user 2 in it. The vehicle user 2 is sitting on a seat 10, which is part of the interior system 7. The vehicle 1 comprises the chassis system 4, the regulating device 6, the position planning device 5, and the HMI system with its output device 9 and its input device 8. In addition the vehicle comprises the interior system 7 which, besides the seat 10, also includes the air-conditioning unit 11.

The regulating device 6 is connected to the input device 8 and the output device 9 of the HMI system 3. Furthermore, the regulating device 6 is connected to the chassis system 4. In addition the regulating device 6 is connected to the seat 10 and the air-conditioning unit 11 of the interior system 7. Moreover, the regulating device 6 is connected to the position planning device 5. Thus, the regulating device 6 can control the chassis system 4, the HMI system 3, the interior system 7 and the position planning device 5.

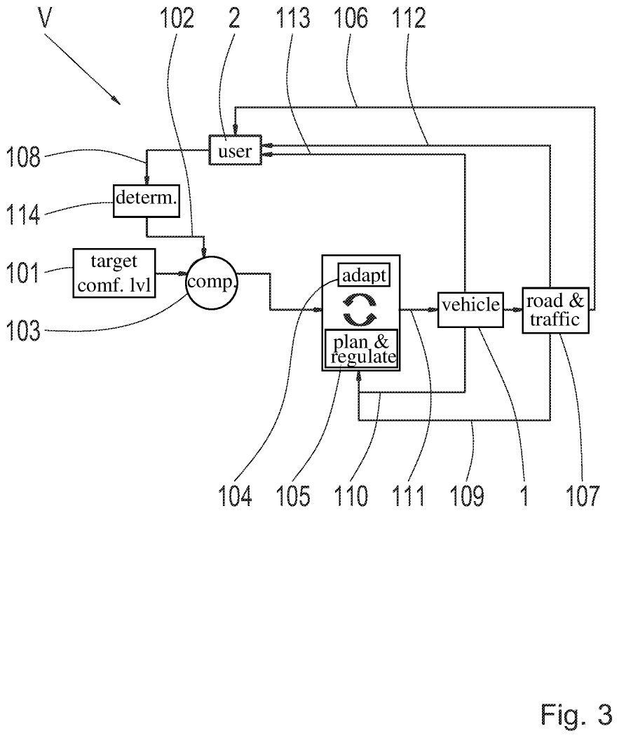

By way of the input device 8, the HMI system 3 determines a current comfort level of the vehicle user 2. This can take place, for example, by monitoring the driver's condition by means of a vitality parameter measurement or by means of an attentiveness assessment. Other options for establishing the current comfort level of the vehicle user 2 are also possible, for example the vehicle user 2 can input his current comfort level. In the data memory of the HMI system 3 is stored a target comfort level of the vehicle user 2. The target comfort level of the vehicle user 2 is compared with the current comfort level of the vehicle user 2. This comparison is carried out continuously, as shown in greater detail in FIG. 3. If now the current comfort level of the vehicle user 2 differs from the target comfort level of the vehicle user 2, the regulating device 6 actuates the various systems of the vehicle 1 in order to bring the current comfort level of the vehicle user 2 closer to the target comfort level.

The regulating device 6 actuates the chassis system 4 so that a position of the vehicle user 2 relative to the roadway is changed. This change takes place, for example, in such manner that when driving round a curve smaller forces act upon the vehicle user. For this, for example, the chassis of the chassis system 4 is designed to be adaptive. When a drive around a curve is imminent, this is passed on by the position planning device 5 to the regulating device 6. The position planning device 5 also passes on to the regulating device 6 information about speeds, accelerations, trajectories and similar parameters that occur on a driving route.

The regulating device 6 also actuates the output device 9 of the HMI system 3. The output device 9 of the HMI system 3 indicates to the vehicle user 2 what speeds, accelerations and tilt angles will occur now and in the future during the journey in the vehicle 1. That information has been obtained by the regulating device 6 from the position planning device 5. Thus, what is to happen now and in the future while traveling in the vehicle 1 is communicated to the vehicle user 2 by way of the output device 9. Accordingly, the vehicle user 2 can ready himself for the present and future situations. This increases or improves the current comfort level of the vehicle user 2.

Furthermore the regulating device 6 actuates the vehicle seat 10 of the interior system 7. Thereby, a sitting position of the vehicle user 2 is changed. This change can for example be such that the vehicle user 2 is sitting more comfortably. That has a positive effect on the comfort level of the vehicle user 2.

The regulating device 6 also controls the air-conditioning unit 11 of the interior system 7. For example, a flow of air into the vehicle 1 is substantially increased and a temperature inside the vehicle 1 is adapted by the regulating device 6 to make it pleasant for the vehicle user 2. The temperature that the vehicle user 2 finds pleasant can be set by the user, for example, before the journey begins. That temperature is then stored in the memory of the regulating device 6.

Since during a journey in the vehicle 1 the current comfort level of the vehicle user 2 is determined continuously and continuously compared with the target comfort level, the regulating device 6 regulates all the systems to which it is connected until the current comfort level of the vehicle user 2 coincides with the target comfort level. This control cycle is represented more precisely in FIG. 3.

FIG. 3 shows a schematic representation of an example embodiment of a control cycle carried out by the regulating device 6 of FIG. 1 during the implementation of the method V. The central feature of the control cycle is the comparison 103 between the target comfort level 101 and the current comfort level 102 of the vehicle user. This current comfort level 102 is determined continuously at 114. The determination 114 of the current comfort level 102 of the vehicle user 2 takes into account, for example, an attentiveness level, a state of mind or an expected driving style. That is represented by the arrow 108.

During a journey in the vehicle various factors affect the vehicle user 2. For example the roadway and the existing traffic 107 have a direct effect 106 on the vehicle user 2. This is the case when, for example, evasive action, braking operations, acceleration processes or similar have to be carried out. These effects 106 are of a physical nature because forces act upon the vehicle user 2. Moreover, the roadway and the traffic 107 have other effects on the vehicle user 2. The visibility of the route to be covered influences the vehicle user 2. When the user can observe the route clearly, these effects are different from when the user cannot see the route. This results in a change of the current comfort level 102 of the vehicle user 2. The display 113 of the current and future drive dynamics and trajectories directly affects the current comfort level 102 of the vehicle user 2. That display takes place by way of the HMI system.

In turn, the vehicle 1 influences both the movement planning and the regulation 105 by means of the position planning device 5, and also the adaptation 104 of the chassis system 4. In this, the adaptation 104 of the chassis system 4 and the movement planning and regulation 105 by means of the position planning device 5 have a reciprocal influence on one another. That is indicated by the double arrow. Furthermore, the roadway and the traffic 107 in turn have a direct influence on both the position planning device 5 and the chassis system 4. This is because the roadway and the traffic 107 provide the prerequisites in relation to the infrastructure and environmental conditions 109. The position planning device 5, which is responsible for the movement planning and the regulation 105 of that movement, and the chassis system 4, which is adapted 104, are therefore influenced by the roadway and traffic 107 and by the vehicle 1 itself. Likewise, the vehicle 1 is influenced by the movement planning and the regulation 105 by means of the position planning system 5 and by the adaption 104 of the chassis system. Namely, both the steering and the acceleration and also the chassis parameters of the vehicle 1 are influenced. Furthermore, the vehicle 1 itself, of course, has an effect on the traffic and the roadway 107.

The movement planning and regulation 105 by means of the position planning device and the adaptation 104 of the chassis system take place on the basis of the comparison 103 between the target comfort level 101 and the current comfort level 2. Thus, there is a complex regulation cycle of the method V for adapting the comfort of the vehicle user 2.

The examples represented here are chosen only as examples. For instance, the regulation cycle can include other factors as well, such as an interior system and further subsystems. Moreover, the current comfort level of the vehicle user can have a direct influence on the movement planning and regulation of the movement by means of the position planning device.

### INDEXES

1 Vehicle
2 Vehicle user
3 HMI system
4 Chassis system
5 Position planning device
6 Regulating device
7 Interior system
8 Input device
9 Output device
10 Seat
11 Air-conditioning unit
V Method
101 Target comfort level
102 Current comfort level
103 Comparison
104 Adaptation of the chassis system
105 Movement planning and regulation by means of the position planning device
106 Effect of the roadway and traffic on the vehicle user
107 Roadway and traffic
108 Attentiveness level, state of mind, expected driving style
109 Prerequisites relating to infrastructure and environmental conditions
110 Driving dynamics
111 Influence on the steering, acceleration and chassis parameters
112 Visibility of the route to be driven along
113 Display of the current and future driving dynamics and trajectories
114 Determination of the current comfort level

1-13. (canceled)

14. A method (V) of adapting comfort of a vehicle (1) for at least one vehicle user (2), the vehicle (1) having
an HMI system (3) for interaction between the at least one vehicle user (2) and the vehicle (1),
a chassis system (4) for adapting a position of the at least one vehicle user (2) relative to a roadway,
a position planning device (5) for planning and regulating a movement (105) of the vehicle (1), and
a regulating device (6), which is connected to the HMI system (3), the position planning device (5) and the chassis system (4), and the regulating device (6) having a memory, the method comprising:
storing, in the memory of the regulating device (6), a target comfort level (101) for the at least one vehicle user (2);
continuously determining, by the HMI system (3), a current comfort level (102) of the at least one vehicle user (2);
continuously comparing (103) the current comfort level (102) with the target comfort level (101); and
actuating the chassis system (4) with the regulating device (6) based on a result of the comparison to adapt the position of the at least one vehicle user (2) relative to the roadway in such manner that the current comfort level (102) continues approaching the target comfort level (101) until the target comfort level (101) is reached.

15. The method (V) according to claim 14, further comprising adapting, with the regulating device (6), the chassis system (4) based on the result of the comparison, and controlling the HMI system (3) with the regulating device (6), and communicating, via the HMI system (3), current movement data from the position planning device (5) of the vehicle (1) to the at least one vehicle user (2) such that the current comfort level (102) continues approaching the target comfort level (101) until the target comfort level (101) is reached.

16. The method (V) according to claim 15, further comprising communicating, via the HMI system (3), future movement data from the position planning device (5) of the vehicle (1) to the at least one vehicle user (2).

17. The method (V) according to claim 14, further comprising controlling, with the regulating device (6), an interior system (7) of the vehicle (7), which is connected to the regulating device (6), to adapt the interior system (7) in such manner that the current comfort level (102) continues approaching the target comfort level (101) until the target comfort level (101) is reached.

18. The method (V) according to claim 14, further comprising determining, with the HMI system (3), an attentiveness level of the at least one vehicle user (2) such that the attentiveness level is related to the current comfort level (102).

19. The method (V) according to claim 14, further comprising planning trajectories of the vehicle (1), with the position planning device (5), as part of movement data, and communicating the trajectories, via the HMI system (3), to the at least one vehicle user (2).

20. The method (V) according to claim 14, further comprising controlling, with the regulating device (6), the position planning device (5) to adapt the planning of the movement (105) of the vehicle (1) in such manner that the current comfort level (102) continues approaching the target comfort level (101) until the target comfort level (101) is reached.

21. The method (V) according to claim 14, further comprising determining the current comfort level (102) of the at least one vehicle user (2) based on vital parameters determined by the HMI system (3).

22. The method (V) according to claim 15, further comprising communicating, via the HMI system (3), with the at least one vehicle user (2) by at least one of visual, acoustic and haptic means.

23. A regulating device (6) for a vehicle (1), the regulating device (6) being connectable to an HMI system (3) of the vehicle, a chassis system (4) and a position planning device (5) of the vehicle (1), the HMI system (3) facilitating interaction between at least one vehicle user (2) and the vehicle (1), the chassis system (4) adapting a position of the at least one vehicle user (2) relative to a roadway, the position planning device (5) planning and regulating movement (105) of the vehicle (1), and the regulating device (6) having a memory, and the regulating device (6) being configured to implement a method (V) for adapting comfort of the vehicle (1) for the at least one vehicle user (2), the method including:
storing, in the memory of the regulating device (6), a target comfort level (101) for the at least one vehicle user (2);
continuously determining, by the HMI system (3), a current comfort level (102) of the at least one vehicle user (2);
continuously comparing (103) the current comfort level (102) with the target comfort level (101); and
actuating the chassis system (4) with the regulating device (6) based on a result of the comparison to adapt the position of the at least one vehicle user (2) relative to the roadway in such manner that the current comfort level (102) continues approaching the target comfort level (101) until the target comfort level (101) is reached.

24. The regulating device (6) according to claim 24, wherein the regulating device (6) is connectable to an interior system (7).

25. A vehicle (1) for at least one vehicle user (2), the vehicle (1) comprises an HMI system (3), a chassis system (4), a position planning device (5), and a regulating device (6), the regulating device (6) being connectable to the HMI system (3), the chassis system (4) and the position planning device (5), the HMI system (3) facilitating interaction between the at least one vehicle user (2) and the vehicle (1), the chassis system (4) adapting a position of the at least one vehicle user (2) relative to a roadway, the position planning device (5) planning and regulating movement (105) of the vehicle (1), and the regulating device (6) having a memory, and the regulating device (6) being configured to implement a method (V) for adapting comfort of the vehicle (1) for the at least one vehicle user (2), the method including:
storing, in the memory of the regulating device (6), a target comfort level (101) for the at least one vehicle user (2);
continuously determining, by the HMI system (3), a current comfort level (102) of the at least one vehicle user (2);
continuously comparing (103) the current comfort level (102) with the target comfort level (101); and
actuating the chassis system (4) with the regulating device (6) based on a result of the comparison adapt the position of the at least one vehicle user (2) relative to the roadway in such manner that the current comfort level (102) continues approaching the target comfort level (101) until the target comfort level (101) is reached.

26. The vehicle (1) according to claim 25, wherein the vehicle (1) additionally comprises an interior system (7).
